(19) United States
(12) Patent Application Publication
(10) Pub. No.: US 2016/0062617 A1
(43) Pub. Date: Mar. 3, 2016

(54) Map Zooming Based on Semantic Meaning

(71) Applicant: GOOGLE INC., Mountain View, CA (US)

(72) Inventor: Paul Isaacs, San Francisco, CA (US)

(21) Appl. No.: 14/474,793

(22) Filed: Sep. 2, 2014

(51) Int. Cl. G06F 3/0484; G06F 17/30; G09G 5/373

(52) U.S. Cl. CPC G06F 3/04845; G09G 5/373; G06F 17/30241

(57) ABSTRACT

Systems and methods for map zooming based on semantic meaning are provided. One example system includes one or more server computing devices configured to perform first operations. The first operations include receiving a request for a map from a first client device associated with a first user; obtaining user preferences data associated with the first user; and selecting a first semantic group from a plurality of semantic groups based at least in part on the user preferences data. Each of the plurality of semantic groups comprises a plurality of different semantic entities. The first operations include providing the map to the first client device. Zooming functionality provided to the first user allows the first user to zoom a displayed portion of the map between a plurality of different geographic areas respectively associated with the plurality of different semantic entities included in the first semantic group.

### FIELD

The present disclosure relates generally to maps. In particular, the present disclosure is directed to systems and methods for providing zooming functionality between semantic entities in a map.

### BACKGROUND

Geographic information systems, mapping applications, navigational devices, and other similar and related products can allow a user to obtain and explore an interactive map by performing actions such as panning, tilting, and zooming the map. The map can be a stylized representation of various features such as roads, bodies of water etc., or the map can have aerial imagery (e.g. satellite imagery) or other features, or some combination thereof.

Generally, existing mapping applications provide zooming functionality that results in a uniform increase or decrease in the area of the map displayed. For example, zooming operations can be performed by simulating a virtual camera being moved a predefined distance closer or further from the subject along a straight line for each instance of zooming.

Providing zooming in such fashion may be functional, but is slow and inefficient when large amounts of zooming are required. For example, if a user starts with a view of the entire Earth and wants to obtain a map of a certain location such as, for example, her house, the user may be required to use the zoom control many times and keep repositioning the map based on an understanding of what she is viewing and where she would like to view at the next step.

Furthermore, providing uniform zooming functionality regardless of the content of the map being shown divorces the zooming functions from the utility and contextual human understanding of the map. Therefore, systems and methods for providing faster, more intuitive zooming within a map are desired.

### SUMMARY

Aspects and advantages of the present disclosure will be set forth in part in the following description, or may be obvious from the description, or may be learned through practice of embodiments of the present disclosure.

One aspect of the present disclosure is directed to a computer-implemented method for providing maps. The method includes obtaining, by one or more computing devices, user preferences data describing one or more attributes associated with a first user. The method includes selecting, by the one or more computing devices, a first semantic group from a plurality of semantic groups based at least in part on the user preferences data. Each of the plurality of semantic groups comprises a plurality of different semantic entities. A plurality of different geographic areas are respectively associated with the plurality of different semantic entities. The method includes providing, by the one or more computing devices, a map to the first user. The map comprises at least a portion of one or more of the plurality of different geographic areas. The method includes providing, by the one or more computing devices, zooming functionality within the map to the first user based at least in part on the first semantic group. The zooming functionality allows the first user to zoom a displayed portion of the map between the plurality of different geographic areas respectively associated with the plurality of different semantic entities included in the first semantic group.

Another aspect of the present disclosure is directed to a system for providing maps. The system includes one or more server computing devices configured to perform first operations. The first operations include receiving a request for a map from a first client device associated with a first user. The first operations include obtaining user preferences data associated with the first user. The first operations include selecting a first semantic group from a plurality of semantic groups based at least in part on the user preferences data. Each of the plurality of semantic groups comprises a plurality of different semantic entities. A plurality of different geographic areas are respectively associated with the plurality of different semantic entities. The first operations include providing the map to the first client device. Zooming functionality is provided to the first user within the map based at least in part on the first semantic group. The zooming functionality allows the first user to zoom a displayed portion of the map between the plurality of different geographic areas respectively associated with the plurality of different semantic entities included in the first semantic group.

Another aspect of the present disclosure is directed to one or more non-transitory, computer-readable media storing instructions that, when executed by one or more computing devices, cause the one or more computing devices to perform operations. The operations include providing a first map displaying a first geographic area associated with a first semantic entity of a plurality of semantic entities in a semantic group. The plurality of semantic entities of the semantic group are organized according to a hierarchy based at least in part on a plurality of geographic areas respectively associated with the semantic entities. The operations include receiving data describing a user input from a first user specifying a point on the first map about which a zoom operation is desired. The operations include identifying a second semantic entity of the plurality of semantic entities based at least in part on the point on the first map and based at least in part on user preferences data associated with first user. The second semantic entity is one level from the first semantic entity in the hierarchy. The operations include providing a second map displaying a second geographic area associated with the second semantic entity.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling description of the present disclosure, directed to one of ordinary skill in the art, is set forth in the specification, which makes reference to the appended figures, in which:

FIGS. 1A-1C depict an example mapping application providing map zooming based on semantic meaning according to an example embodiment of the present disclosure;

FIG. 2 depicts an example system for providing maps according to an example embodiment of the present disclosure;

FIG. 3 depicts an example hierarchy of semantic entities according to an example embodiment of the present disclosure;

FIG. 4 depicts a flow chart of an example method for providing maps according to an example embodiment of the present disclosure;

FIG. 5 depicts a client-server flow chart of an example method for providing maps according to an example embodiment of the present disclosure; and

FIG. 6 depicts a flow chart of an example method for providing maps according to an example embodiment of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

### Overview

Generally, the present disclosure is directed to systems and methods for providing zooming functionality between semantic entities in a map. In particular, certain existing mapping applications can provide zoom operations that result in a uniform increase or decrease in the area of the map displayed (e.g. by simulating a virtual camera being moved a predefined distance closer or further from the subject along a straight line). However, according to the present disclosure, zooming operations within the map can result in the displayed portion of the map being transitioned between defined geographic areas that correspond to semantic entities. For example, semantic entities can correspond to political entities (e.g. cities, states, or countries), national parks, neighborhoods, property boundaries, rooms within a building, various segmentations of geographic area according to various criteria (e.g. according to population demographics), or other geographic areas or places that have some human meaning or context.

Thus, a certain geographic area can be associated with each semantic entity and zooming can be provided between such geographic areas. In particular, zooming can include adjusting a map (e.g. by manipulating a virtual camera) to display different geographic areas. For example, the displayed portion of the map can be centered about and scaled relative to the geographic area associated with the semantic entity being shown. As such, in some embodiments, zooming can include performing operations such as dollying, panning, tilting, trucking, pedestaling, craning, and/or rotating a virtual camera in three-dimensional space.

Furthermore, according to an aspect of the present disclosure, the semantic entities among which zooming is provided can be different for each map user (e.g. viewer or operator) and map context (e.g. portal or device through which the map is being accessed). As an example, in some embodiments, semantic entities throughout the world can be organized into a plurality of different semantic groups. Each semantic group can include a plurality of semantic entities.

Thus, in some embodiments, providing the map can include selecting a first semantic group of such plurality of semantic groups. Zooming operations within the map can then be performed between the semantic entities included in the selected first semantic group.

In particular, according to an aspect of the present disclosure, the first semantic group can be selected from the plurality of semantic groups based at least in part on user preferences data associated with a first user operating the map. For example, the user preferences data can include data describing one or more previous interactions between the first user and the map (e.g. operations indicating that the first user has been exploring different national parks). As other examples, the user preferences data can include user search data associated with the first user, a user location history associated with the first user, user input specifying particular categories of desired semantic entities, and/or other data describing various preferences of the first user.

Thus, in some embodiments, in order to obtain the benefits of the techniques described herein, the user may be required to allow the collection and analysis of user preferences data associated with the user or her device or other information concerning attributes of the user. For example, in some embodiments, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed.

Thus, by taking into account user preferences data describing a current objective or interest of the first user, an appropriate semantic group can be selected for the first user. For example, if the first user has recently been searching for campgrounds in various national parks, then a semantic group that includes semantic entities generally including or focused on national parks or outdoor recreational entities can be selected for the first user. As another example, such semantic group can be selected in response to user input specifying “national parks” as a particular interest. As a result, the first user will be able to quickly zoom the displayed portion of the map between geographic areas corresponding to relevant semantic entities (e.g. particular parks and their campgrounds or other features), rather than repeatedly performing uniform, non-contextual zooming operations to reach particular portions of the map.

As another example, in some embodiments, selecting the semantic group for the first user can include generating the first semantic group based at least in part on the user preferences data. For example, the semantic group can be generated by selecting one or more of the semantic entities that make up the first semantic group based on the user preferences data. For example, available semantic entities can be identified and scored based on the user preferences data (e.g. by inputting the user preferences data into search algorithms to identify and score semantic entities as potential search results). Semantic entities that receive a significant score can be added to the first semantic group. The first semantic group can be updated or revised over time. Thus, in some embodiments, user preferences data can be used to generate a user-specific semantic group to be used.

Further, in some embodiments, semantic entities identified based on user preferences data can be added to an existing semantic group to generate a new semantic group. For example, user-specific semantic entities such as a home location or a work location can be added to an existing semantic group (e.g. political entities such as states, counties, and cities) to generate a new, user-specific semantic group. As another example, semantic entities that the user has previously visited (e.g. as indicated by a user location history) or semantic entities that the user has flagged or otherwise marked can be added to an existing semantic group. For example, the first user may have previously marked various locations as being landmarks or monuments. Such locations can be added as semantic entities to an existing semantic group that includes semantic entities corresponding to well-known landmarks around the world.

As another example, in some embodiments, alternatively or in addition to the user preferences data, the semantic group can be selected for the first user based at least in part on an identity of a portal through which the map is provided to the first user. As an example, in some embodiments, the map can be controlled and provided by a central mapping service performed by one or more server computing devices. In certain instances, the first user may access the map directly via communication between a client device operated by the first user and the central mapping service (e.g. using a mapping application developed by the central mapping service entity). However, in other instances, the map may be provided to the first user via a third-party portal. For example, the map may be embedded within the website of a third party or accessed via a mapping application developed by a third party which uses map data from the central mapping service. Thus, the identity of the portal through which the map is accessed can impact the selection of the semantic group. In particular, the identity of the portals can be used to identify different use cases for the map.

As an example, if the map is embedded in a website dedicated to providing voting results or demographic data regarding voting trends, then the identity of such website may impact the selection of semantic groups such that a semantic group including semantic entities relevant to voting (e.g. states, counties, and/or congressional districts) is selected. However, if the map is embedded in a website dedicated to exploring the effects of job creation, then a semantic group may be selected that includes semantic entities corresponding to contextual geographic divisions of economic influence (e.g. “Silicon Valley” and North Carolina's “Research Triangle”).

Membership of semantic entities in certain semantic groups can be revised or refined over time. As an example, in some embodiments, feedback from users for whom a certain semantic group was selected can influence membership of semantic entities in such semantic group. For example, if a large percentage of users re-adjust the scale or zoom-level of the map when a certain semantic entity is depicted or otherwise perform operations indicating that the semantic entity does not meet their expectations with respect to semantic group membership, then such semantic entity can be removed from the group or otherwise modified. As another example, user feedback collected with respect to a first semantic group can impact a second semantic group if the two semantic groups are related. For example, a semantic group focused on urban parks may be impacted by user operations performed within a map offering zooming functionality based on a semantic group focused on urban greenways.

According to another aspect of the present disclosure, in some embodiments, the semantic entities in each group can be organized according to a hierarchy. The zooming between semantic entities in a group can be performed based at least in part on the hierarchy. For example, a zoom out operation can result in transitioning the displayed portion of the map from a first geographic area corresponding to a first semantic entity to a second geographic area corresponding to a second semantic entity, where the second semantic entity is one level above the first semantic entity in the hierarchy. Likewise, a zoom in operation may result in transitioning the displayed portion of the map from the first semantic entity to a third semantic entity that is one level below the first semantic entity in the hierarchy.

In some embodiments, the hierarchies can be directed graphs. For example, the directed graph for each semantic group can consist of a plurality of nodes that respectively correspond to the plurality of semantic entities included within such semantic group. Directed edges between various nodes can define directed relationships between semantic entities.

In some embodiments, the zooming between semantic entities in a group can be performed based at least in part on the directed graph. For example, a zoom out operation can result in transitioning the displayed portion of the map from a first geographic area corresponding to a first semantic entity to a second geographic area corresponding to a second semantic entity, where the second semantic entity is connected by an edge directed from the second semantic entity to the first semantic entity. Likewise, a zoom in operation may result in transitioning the displayed portion of the map from the first semantic entity to a third semantic entity, where a directed edge extends from the first semantic entity to the third semantic entity.

According to another aspect of the present disclosure, in some embodiments, user preferences data can provide additional information used to enhance or improve the particular perspective or framing that results from the map being zoomed to a particular semantic entity. Thus, user-specific views or display techniques can be associated with particular semantic entities and stored as user preferences.

As an example, at the first (or other) instance in which a user zooms to the semantic entity corresponding to her house, the user may adjust the displayed view of the semantic entity to a certain perspective. For example, the user may change an initial top-down view of her house to a certain perspective that provides additional three-dimensional detail (e.g. by interacting with the mapping application to adjust a position and orientation of a virtual camera). A system implementing the present disclosure can capture such perspective (e.g. either through explicit saving or flagging by the user or through more sophisticated tracking of user-map interactions and/or activity). Thus, upon subsequent zooming to the semantic entity corresponding to the user's house, the user can be provided with the personalized perspective she previously created (e.g. as indicated by camera parameters stored within her user preferences data).

According to another aspect of the present disclosure, in some instances a zoom operation can be requested about a point on a map where the geographic areas of two or more semantic entities overlap. The two or more semantic entities may be included in the same semantic group or may belong to different semantic groups. For example, a user may be viewing a map depicting the San Francisco Bay area. The user may request to zoom in about a point that is included in both the geographic area corresponding to the semantic entity “Silicon Valley” and the geographic area corresponding to the semantic entity “San Jose Metropolitan Area.”

In response to the zoom request, one of the two or more overlapping semantic entities can be selected as the target of the zoom request. In particular, the particular semantic entity can be selected based at least in part on the user preferences data. As an example, in some embodiments, when a zoom operation is ambiguous with respect to two or more semantic entities, the potential candidates for zooming can be scored based on the user preferences data. For example, previous searches, a user location history, or other information can be used to select one of the semantic entities for performing the resulting zoom operation.

As another example, in some instances the point on the map about which the zoom operation is requested may be sufficiently close to the geographic areas respectively associated with two or more semantic entities so as to create ambiguity regarding the target of the zoom request, even though the point about which zooming is requested may not lie within an overlapping region or the two semantic entities do not, in fact, overlap geographically. In such instances, the potential candidates for zooming can be scored based on the user preferences data as discussed above.

For example, if a user requests a zoom in operation to be performed about a point in the center of her neighborhood in a map image that is sufficiently zoomed out, the point might be equidistant (or nearly equidistant) from both her home and her work. Thus, while the semantic entities corresponding to her home and work locations do not overlap, her request to zoom in may be attributable to either location. Therefore, user preferences data can be used to disambiguate the request by selecting one of the multiple semantic entities. For example, if the user is currently located at her home, then her home may be located in favor of her work.

In further embodiments, instead of selecting a particular semantic entity as the target of a zoom request when the zoom request is ambiguous with respect to multiple potential semantic entities, the map can be adjusted so as to frame two or more (e.g. all) of the potential semantic entities. Thus, to continue the example provided above, in response to the user's zoom request that is ambiguous with respect to her home and work locations, the map can be zoomed in so as to frame both her home and work locations, but not further.

Thus, the systems and methods of the present disclosure can provide for enhanced, personalized zooming functionality within a map. In particular, one of a plurality of different semantic groups can be selected, individualized, and/or continually revised for a user based on user preferences data or other relevant information. Zooming can then be provided between geographic areas corresponding to different semantic entities within the selected semantic group. For example, zooming can be performed in a hierarchical manner to provide an intuitive navigational user experience.

With reference now to the FIGS., example embodiments of the present disclosure will be discussed in further detail.

### Example User Experience

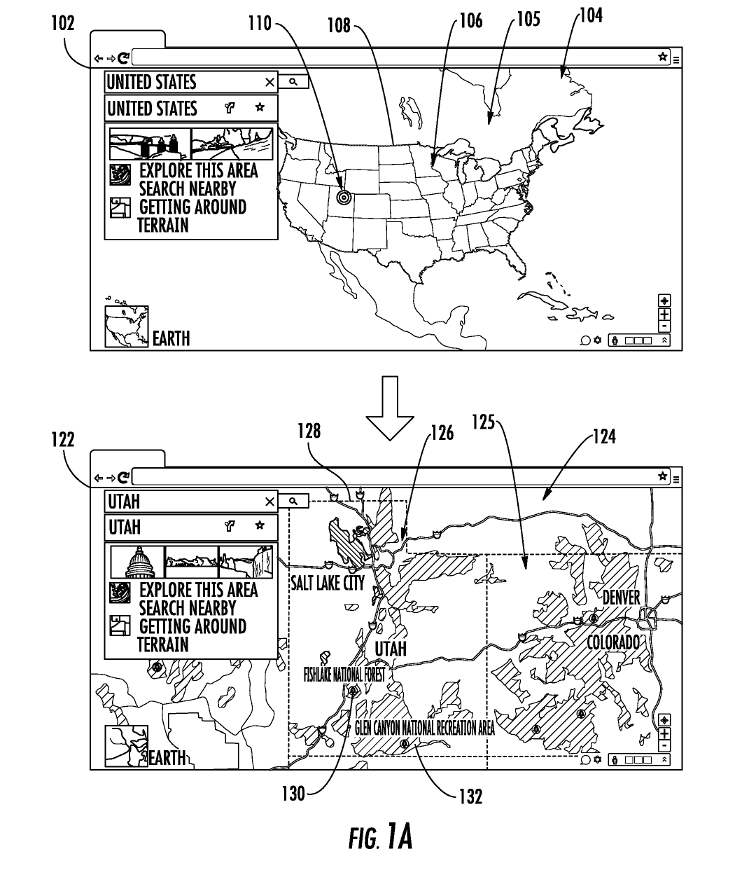

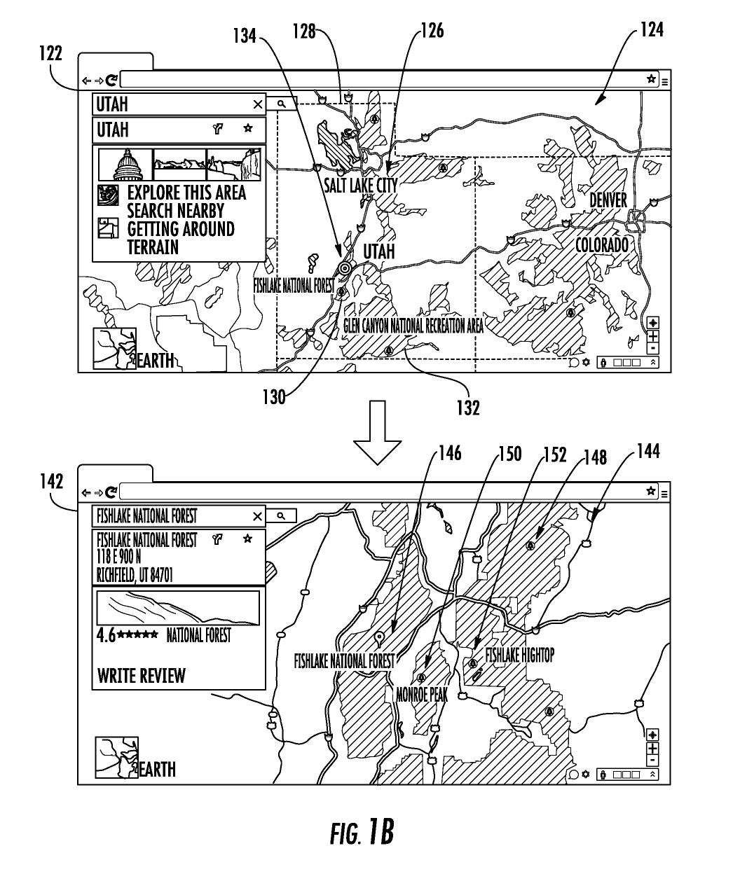

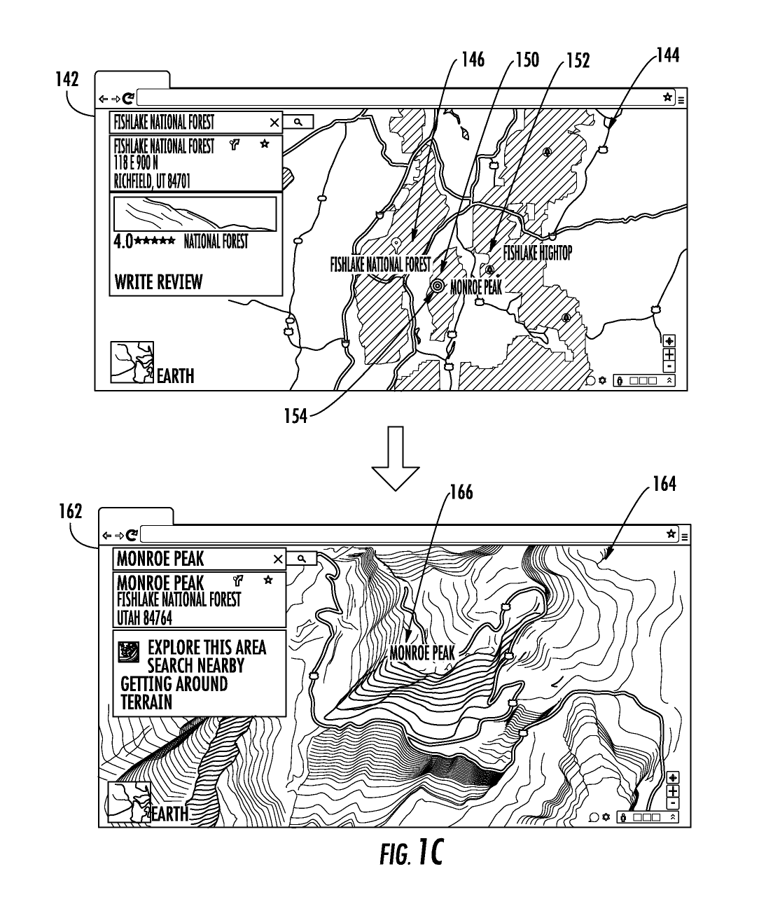

FIGS. 1A-1C depict an example mapping application providing zooming functionality between semantic entities according to an example embodiment of the present disclosure. In particular, the zooming can be provided between certain semantic entities that belong to a selected semantic group. The particular semantic group for which map zooming is provided may have been selected based at least in part on user preferences data describing user preferences or a use case for which the user is desiring to explore the map.

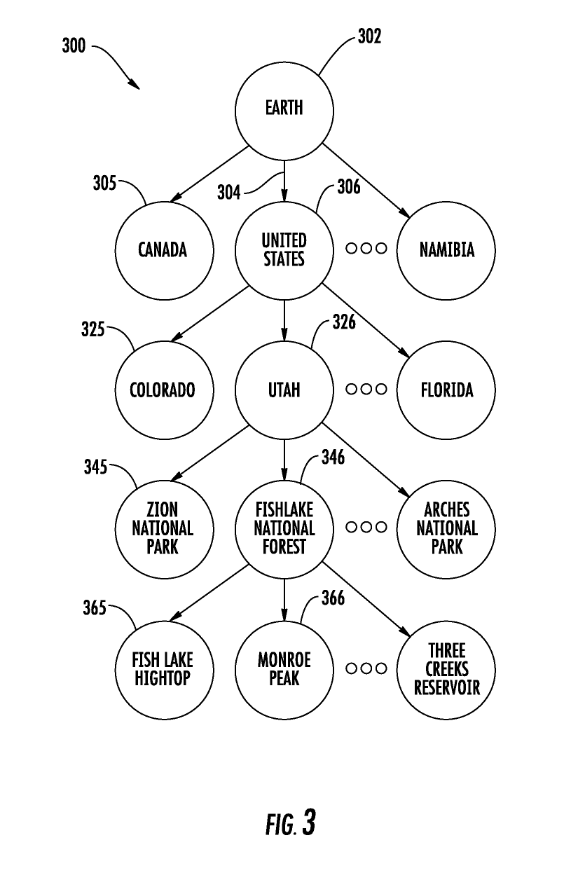

As an example, a user may have previously been searching for information concerning national parks and various mountain peaks within such parks. Therefore, a semantic group containing semantic entities relevant to national parks may have been constructed or selected for such user. For example, FIG. 3 provides one example semantic group that includes semantic entities relevant to national parks. The user will be able to interact with the map to zoom between geographic areas associated with the semantic entities included within such selected semantic group.

Further, in some embodiments, the zooming functionality can be performed according to a hierarchy in which the semantic entities of the selected semantic group are organized. For example, FIG. 3 provides one example hierarchy 300 and will be discussed together with FIGS. 1A-1C.

In particular, as an example, hierarchy 300 is a directed graph that includes a plurality of nodes (e.g. nodes 302, 306, and 326) and directed edges between certain nodes. For example, edge 304 extends from node 302 to node 306. In some embodiments, a first node (e.g. node 302) from which an edge is directed to a second node (e.g. node 306) can be viewed as being one level “higher” than the second node. Likewise, in some embodiments, the second node can be viewed as being one level “lower” than the first node.

To provide one example of a user experience, referring first to FIG. 1A, user interface 102 of the mapping application displays a portion of a map 104. The displayed portion of the map 104 includes various semantic entities, including, for example, a semantic entity 105 corresponding to the country of Canada and a semantic entity 106 corresponding to the country of the United States of America. A geographic area can be associated with each semantic entity. For example, the geographic area associated with semantic entity 106 can be defined by a boundary 108.

The portion of the map 104 displayed by user interface 102 is currently centered about and scaled relative to the geographic area associated with the semantic entity 106. Thus, for example, referring to FIG. 3, the portion of the map 104 displayed by user interface 102 may correspond to node 306.

As shown in FIG. 1A, the user has requested a zoom in operation to be performed about point 110 on map 104. The zoom in operation may be requested by any suitable means including, as examples, double clicking at point 110, rolling a scroll wheel of a mouse forward while the cursor is hovering over point 110, double tapping at point 110 when a touch-sensitive device is used, or other user inputs. In response to request for the zoom in operation to be performed about point 110, the displayed portion of the map is transitioned to display the geographic area associated with a different semantic entity, as shown in user interface 122.

In particular, because the point 110 on the map was included within a geographic boundary 128 associated with a semantic entity 126 corresponding to the state of Utah, user interface 122 now displays of portion of a map 124 that is centered about and scaled relative to the state of Utah. Portions of the geographic areas of other adjacent semantic entities are shown in map 124, including, for example, a portion of the geographic area associated with a semantic entity 125 corresponding to the state of Colorado.

In addition, the locations of various other semantic entities corresponding to national parks or other related outdoor recreation areas are shown. For example, the respective locations of a semantic entity 130 corresponding to Fishlake National Forest and a semantic entity 132 corresponding to Glen Canyon National Recreation Area are shown in the displayed portion of the map 124.

Thus, referring to FIG. 3 for example, in response to the user request for the zoom in operation performed with respect to the map showing the geographic area associated with node 306, a system implementing the present disclosure may identify the various nodes (e.g. nodes 325 and 326) to which an edge extends from node 306. If the zoom in operation is requested about a point which lies within the geographic area corresponding to one of such nodes (e.g. node 326), then the zoom level and location of the displayed portion of the map may be adjusted so that the displayed portion of the map is centered about and scaled relative to the geographic area associated with the identified node. Thus, for example, user interface 122 displays a portion of a map 124 that is centered about and scaled relative to the state of Utah. In such fashion, zooming functionality can be provided between semantic entities within a semantic group.

As another example, referring now to FIG. 1B, the user has requested a zoom in operation to be performed about point 134 on map 124. In response to such request, the displayed portion of the map is transitioned to display the geographic area associated with a different semantic entity, as shown in user interface 142.

In particular, because the point 134 on the map was included within a geographic area associated a semantic entity 130 corresponding to Fishlake National Forest, user interface 142 now displays of portion of a map 144 that is centered about and scaled relative to Fishlake National Forest. Portions of the geographic areas of other adjacent semantic entities are shown in map 144, including, for example, a portion of the geographic area associated with a semantic entity 148 corresponding to Manti-La Sal National Forest.

In addition, the locations of various other semantic entities corresponding to mountain peaks or other related geographic features within the national parks or forests are shown. For example, the respective locations of a semantic entity 150 corresponding to Monroe Peak within Fishlake National Forest and a semantic entity 152 corresponding to Fish Lake Hightop within Fishlake National Forest are shown in the displayed portion of the map 144.

Thus, referring to FIG. 3 for example, in response to the user request for the zoom in operation performed with respect to the map showing the geographic area associated with node 326, a system implementing the present disclosure may identify the various nodes (e.g. nodes 345 and 346) to which an edge extends from node 326. If the zoom in operation is requested about a point which lies within the geographic area corresponding to one of such nodes (e.g. node 346), then the zoom level and location of the displayed portion of the map may be adjusted so that the displayed portion of the map is centered about and scaled relative to the geographic area associated with the identified node. Thus, for example, user interface 142 displays of portion of a map 144 that is centered about and scaled relative to Fishlake National Forest.

As yet another example, referring now to FIG. 1C, the user has requested a zoom in operation to be performed about point 154 on map 144 of user interface 142. In response to such request, the displayed portion of the map is transitioned to display the geographic area associated with a different semantic entity, as shown in user interface 162.

In particular, because the point 154 on the map was included within a geographic area associated a semantic entity 150 corresponding to Monroe Peak within Fishlake National Forest, user interface 162 now displays of portion of a map 164 that is centered about and scaled relative to Monroe Peak

Thus, referring to FIG. 3 for example, in response to the user request for the zoom in operation performed with respect to the map showing the geographic area associated with node 346, a system implementing the present disclosure may identify the various nodes (e.g. nodes 365 and 366) to which an edge extends from node 346. If the zoom in operation is requested about a point which lies within the geographic area corresponding to one of such nodes (e.g. node 366), then the zoom level and location of the displayed portion of the map may be adjusted so that the displayed portion of the map is centered about and scaled relative to the geographic area associated with the identified node. Thus, for example, user interface 162 displays of portion of a map 164 that is centered about and scaled relative to Monroe Peak within Fishlake National Forest.

The maps shown in FIGS. 1A-1C are provided as example maps only. Many different types or styles of maps can be used by the present disclosure. For example, although the maps shown in FIGS. 1A-1C are two-dimensional in nature, three-dimensional maps can be used as well. For example, zooming to a particular semantic entity within a three-dimensional map can include displaying a three-dimensional model of the particular semantic entity from a particular perspective (e.g. location and orientation).

The semantic group and associated hierarchy 300 depicted in FIG. 3 is provided as one example only. Many different semantic groups covering many different topics, categories, or divisions of semantic entities can be used by the present disclosure. Furthermore, although hierarchy 300 is provided as a directed graph, other hierarchical data structures may be used as well, including a tiered or layered hierarchy, a non-directed graph, or other structures.

In addition, although each node included in the directed graph receives a directed edge from only a single other node, this is provided as an example only. Nodes may receive directed edges from any number of other nodes. As one example, a node corresponding to Cache National Forest may respectively receive directed edges from two nodes respectively corresponding to the semantic entities of Utah and Idaho, as the Cache National Forest includes geographic area in each of such states. Other non-geographic relationships between semantic entities can exist as well.

### Example Systems

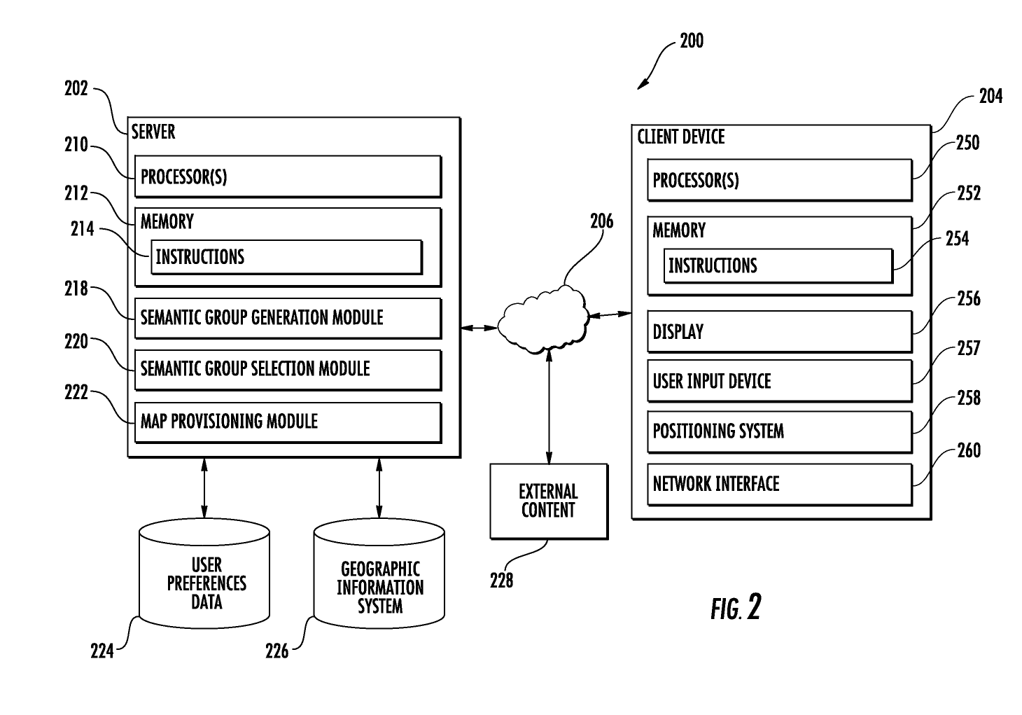

FIG. 2 depicts an example system 200 for providing maps according to an example embodiment of the present disclosure. System 200 can include a client-server architecture, where a server 202 communicates with one or more client devices 204 over a network 206. Although a single client device 204 is illustrated in FIG. 2, any number of client devices can be connected to server 202 over network 206.

Server 202 can be implemented using one or more suitable computing devices. In the instance that server 202 is implemented using a plurality of computing devices, the functionality provided by server 202 can be performed according to any suitable computing architecture, including parallel computing architectures, sequential computing architectures, or some combination thereof.

Server 202 can include one or more processors 210 and one or more memories 212. Processor 210 can be any suitable processing device (e.g. a controller, microcontroller, integrated circuits, central processing units, and/or other processing components) and can be one processor or a plurality of processors which are operably connected. The one or more memories 212 can be RAM, ROM, flash memory, disk storage, virtual memory, and/or other components for storing information or data.

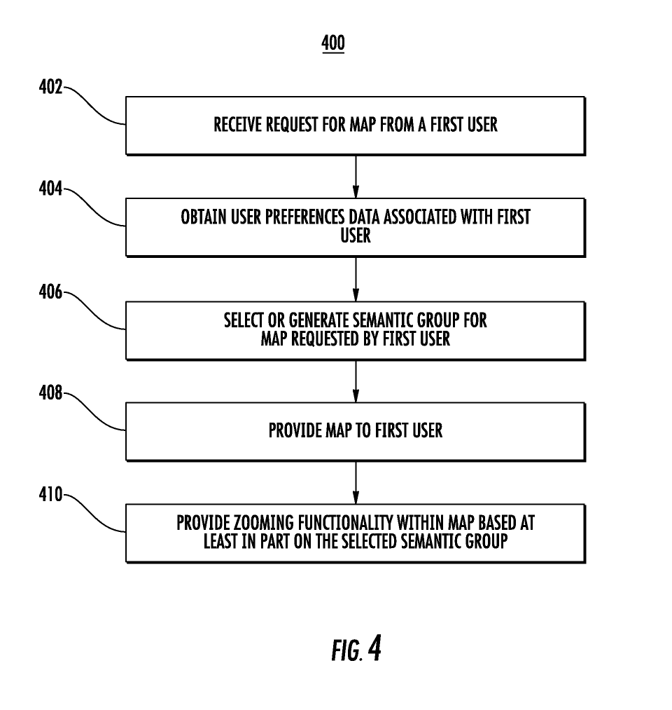

Memory 212 can store instructions 214 that cause processor 210 to perform operations to implement the present disclosure, including performing aspects of methods (400), (500), and (600) of FIGS. 4, 5, and 6, respectively. Server 202 can communicate with client device 204 over network 206 by sending and receiving data.

Server 202 can also include various modules that, when implemented, cause server 202 to perform certain functionality. In particular, in some embodiments, server 202 can include a semantic group generation module 218, a semantic group selection module 220, and a map provisioning module 222.

It will be appreciated that the term “module” refers to computer logic utilized to provide desired functionality. Thus, a module can be implemented in hardware, firmware, and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

Server 202 can implement semantic group generation module 218 to generate a plurality of semantic groups that each contain a plurality of different semantic entities. In some embodiments, the semantic entities included in each semantic group can be organized according to a hierarchy.

In particular, as an example, semantic group generation module 218 can be implemented to identify various semantic entities and sort them into groups (e.g. through use or analysis of a knowledge graph describing relationships among various semantic entities). The groups can be exclusive or non-exclusive. In some embodiments, administrative user input can be used to guide or perform the creation or revision of semantic groups.

As another example, semantic group generation module 218 can be implemented to generate a user-specific semantic group based at least in part on the user preferences data 224 associated with a particular user. For example, semantic group generation module 218 can generate the semantic group by selecting one or more semantic entities based on the user preferences data. For example, available semantic entities can be identified and scored based on the user preferences data (e.g. by inputting the user preferences data into search algorithms to identify and score semantic entities as potential search results). Semantic entities that receive a significant score can be added to the semantic group. Semantic group generation module 218 can update or revise the generated semantic group over time. Thus, in some embodiments, user preferences data can be used to generate a user-specific semantic group to be used.

In some embodiments, semantic group generation module 218 can add semantic entities identified based on user preferences data to an existing semantic group to generate a new semantic group. For example, user-specific semantic entities such as a home location or a work location can be added to an existing semantic group (e.g. political entities such as states, counties, and cities) to generate a new, user-specific semantic group. As another example, semantic entities that the user has previously visited (e.g. as indicated by a user location history) or semantic entities that the user has flagged or otherwise marked can be added to an existing semantic group. For example, a first user may have previously marked various locations as being landmarks or monuments. Such locations can be added as semantic entities to an existing semantic group that includes semantic entities corresponding to well-known landmarks around the world.

Further, in some embodiments, semantic group generation module 218 can generate semantic groups based on aggregate user preferences data associated with a plurality of different users. For example, semantic group generation module 218 can analyze a database (e.g. database 224 or an additional database) that stores information about the aggregate preferences of multiple users, if the privacy settings of those users permit collection of storage of such user preferences data. As an example, a new user with no preferences data in a given area may benefit from generation and selection of semantic groups containing semantic entities deemed important or otherwise selected on the basis of explicit or implicit acts of other users. For example, if a certain user is exploring a map of a park and other users have submitted photos of a particular park feature, marked for themselves that they enjoyed the particular park feature, or implicitly flagged the location of the feature by performing extended map viewings of such location, then such location and feature may be identified as a semantic entity and added to one or more semantic groups.

As yet another example, semantic group generation module 218 can be implemented to revise or refine membership of semantic entities in certain semantic groups over time. As an example, in some embodiments, feedback from users for whom a certain semantic group was selected can influence membership of semantic entities in such semantic group. For example, if a large percentage of users re-adjust the scale or zoom-level of the map when a certain semantic entity is depicted or otherwise perform operations indicating that the semantic entity does not meet their expectations with respect to semantic group membership, then such semantic entity can be removed from the group or otherwise modified.

As another example, semantic group generation module 218 can use user feedback collected with respect to a first semantic group to impact a second semantic group if the two semantic groups are related. For example, semantic group generation module 218 can revise a semantic group focused on urban parks based on user operations performed within a map offering zooming functionality based on a semantic group focused on urban greenways.

Server 202 can implement semantic group selection module 220 to select a particular semantic group for a particular instance of a user requesting and/or interacting with a map. In particular, semantic group selection module 220 can be implemented to select a particular semantic group for a user based at least in part on user preferences data 224 associated with such user. For example, in some embodiments, semantic group selection module 220 can be implemented to input various combinations of user preferences data and semantic group data into a scoring formula or scoring matrix to determine a score for each semantic group. The highest scoring semantic group can be selected.

As another example, in some embodiments, alternatively or in addition to the user preferences data, semantic group selection module 220 can be implemented to select the semantic group for a particular user based at least in part on an identity of a portal through which the map is provided to the particular user. As an example, in some embodiments, the map can be accessed directly via communication between a client device 204 operated by a first user and the server 202 (e.g. via a mapping application designed by the entity operating server 202 and installed within memory 252 of client device 204. However, in other instances, the map may be provided to the first user via a third-party portal. For example, the map may be embedded within the website of a third party or accessed via a mapping application developed by a third party which uses map data obtained from the server 202. Thus, the identity of the portal through which the map is accessed can impact the selection of the semantic group. In particular, the identity of the portals can be used to identify different use cases for the map.

As an example, if the map is embedded in a website dedicated to providing voting results or demographic data regarding voting trends, then the identity of such website may impact the selection of semantic groups such that a semantic group including semantic entities relevant to voting (e.g. states, counties, and/or congressional districts) is selected. However, if the map is embedded in a website dedicated to exploring the effects of job creation, then a semantic group may be selected that includes semantic entities corresponding to contextual geographic divisions of economic influence (e.g. “Silicon Valley” and North Carolina's “Research Triangle”).

Server 202 can implement map provisioning module 222 to provide mapping data to one or more client devices 204. In particular, map provisioning module 222 can be implemented to receive requests for certain portions of a map or actions to be taken within a map and, in response, provide map data that implements such requests or actions.

As an example, map provisioning module 222 can provide map data to a client device 204. The map data can be data that the client device 204 uses to visualize or display the map on the display 256 of the client device 204. In some embodiments, the map data can be organized into a plurality of tiles. The client device 204 can receive user input (e.g. a request for a zoom in operation to be performed). The client device 204 can communicate data describing such user input to the server 202 over network 206. The server 202 can implement map provisioning module 222 to respond to the user input by, for example, providing additional map data that the client device 204 uses to render or display the map from a zoomed in perspective (e.g. according to the semantic zooming principles of the present disclosure). Thus, map provisioning module 222 can be implemented to provide various interactive map features via communication of map data to client device 204.

Server 202 can also be coupled to or in communication with one or more databases, including a database providing user preferences data 224, a geographic information system 226, and external content 228. Although databases 224, 226, and 228 are depicted in FIG. 2 as external to server 202, one or more of such databases can be included in memory 212 of server 202. Further, databases 224, 226, and 228 can each correspond to a plurality of databases rather than a single data source.

In some embodiments, the user preferences data 224 can include data describing one or more previous interactions between a particular user and the map (e.g. operations indicating that the particular user has been exploring different national parks). As other examples, the user preferences data can include user search data associated with the particular user, a user location history associated with the particular user, user input specifying particular categories of desired semantic entities, and/or other data describing various preferences of the particular user (e.g. email data or calendar data).

Thus, in some embodiments, in order to obtain the benefits of the techniques described herein, the user may be required to allow the collection and analysis of user preferences data associated with the user or her device or other information concerning attributes of the user. For example, in some embodiments, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed.

As noted above, in some embodiments of the present disclosure, user preferences database 224 can store or provide a plurality of location histories respectively associated with a plurality of users. In particular, when a user elects to participate and has signed into her user account into one of her computing devices, then such user computing device can periodically send a location update to server 202. Alternatively, the user location histories can be built and maintained by a computing system that is separate and unique from server 202 and the user location histories can simply be accessed by server 202.

For example, each location update can identify the presently active user account and a location (e.g. latitude and longitude) and a timestamp identifying the date and time of day. In some implementations, location updates can further include an accuracy indicator and/or other identifying information such as an originating IP address or a WiFi or cell tower identifier.

Additional information can be used to build or supplement a user location history as well. As an example, whenever a user is logged into a user account and performs a web search or uses one or more applications, such as the mapping application, it is possible that such interaction can result in obtaining the user's location. Therefore, an entry can be formed in the associated user location history based on such interaction.

All received location updates can be stored and associated with a particular user so that a user location history is built over time. Furthermore, in the event that the location reports provided by the user computing device 204 simply provide a geo-location (e.g. a latitude and longitude), one or more algorithms or processes can be applied to such location data to identify a particular point of interest (e.g. restaurant or business) that the user likely visited. Thus, the user location history for each user can provide a history of visits by such user to points of interest over time.

User preferences database 224 can store various other information concerning attributes of the user, as well. For example, in the instance in which the user consents to the use of such information, the user's home or work address or other attributes of the user that may be helpful in selecting personalized semantic groups can be stored in database 224.

Geographic information system 226 can store or provide geospatial data to be used by server 202. Exemplary geospatial data includes geographic imagery (e.g., digital maps, satellite images, aerial photographs, street-level photographs, synthetic models, etc.), tables, vector data (e.g. vector representations of roads, parcels, buildings, etc.), point of interest data, or other suitable geospatial data. Geographic information system 226 can be used by server 202 to provide navigational directions, perform point of interest searches, provide point of interest location or categorization data, determine distances, routes, or travel times between locations, or other geographic tasks. In some embodiments, the geospatial data provided by geographic information system 226 can be organized into a plurality of different tiles that correspond to respective geographic areas.

Geographic information system 226 can include or receive data from data sources providing real-time data about current conditions that would affect travel times or other routing considerations. For example, the data sources can include sources of traffic data, weather data, traffic accident data, construction data, and/or detour data. Geographic information system 226 can also store or access information concerning historical travel times, historical traffic patterns, or other time-variant information.

In addition, in some embodiments, a plurality of semantic groups can be stored in geographic information system 226. Alternatively, such semantic groups can be stored elsewhere such as, for example, within memory 212. Each of the plurality of semantic groups can include a plurality of semantic entities.

Computer-based system 200 can further include external content 228. External content 228 can be any form of external content including news articles, webpages, video files, audio files, written descriptions, ratings, game content, social media content, photographs, commercial offers, or other suitable external content. Server system 202 and client device 204 can access external content 228 over network 206. External content 228 can be searched by server 202 according to known searching methods and can be ranked according to relevance, popularity, or other suitable attributes, including location-specific filtering or promotion.

Client device 204 can be a computing device having a processor 250 and a memory 252, such as a wireless mobile device, a personal digital assistant (PDA), smartphone, tablet, navigation system located in a vehicle, handheld GPS system, laptop computer, desktop computer, computing-enabled watch, computing-enabled eyeglasses, gaming console, embedded computing system, or other such devices/systems. In short, client device 204 can be any computer, device, or system that can interact with the server 202 (sending and receiving data) to implement the present disclosure.

Processor 250 can be any suitable processing device (e.g. a controller, microcontroller, integrated circuits, central processing units, and/or other processing components) and can be one processor or a plurality of processors which are operably connected. The memory 252 can be RAM, ROM, flash memory, disk storage, virtual memory, and/or other components for storing information or data, or some combination thereof.

Memory 252 can include instructions 254 that, when implemented by processor 250, cause client device 204 to perform operations to provide functionality. In some embodiments, memory 252 can include one or more application modules for implementing various applications at client device 204. For example, memory 252 can include a browser module for implementing a browser and/or a mapping application module for implementing a client device portion of a mapping application at the client device 204.

Client device 204 can include a display 256 and a user input device 257. Display 256 can be any component or grouping of components for displaying information, such as a map. User input device 257 can be any component or grouping of components for receiving user input including, for example, a mouse, keyboard, touch screen, microphone, and/or other input devices.

Client device 204 can further include a positioning system 258. Positioning system 258 can determine a current geographic location of client device 204 and communicate such geographic location to server 202 over network 206. The positioning system 258 can be any device or circuitry for analyzing the position of the client device 204. For example, the positioning system 258 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In the instance in which the user consents to the use of positional or location data, the positioning system 258 can analyze the position of the client device 204 as the user moves around in the world and provides the current location of client device 204 to the server 202 over network 206. The current location of client device 204 can be displayed on the map and can influence aspects of the present disclosure (e.g. can be used to select between overlapping semantic entities that both satisfy a requested zoom operation).

Client device 204 can further include a network interface 260. Network interface 260 can include any suitable components for interfacing with one more networks, including for example, transmitters, receivers, ports, controllers, antennas, or other suitable components.

Network 206 can be any type of communications network, such as a local area network (e.g., intranet), wide area network (e.g., Internet), or some combination thereof and can include any number of wired or wireless links. In general, communication between the server 202 and a client device 204 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In addition, although system 200 of FIG. 2 employs a client-server architecture, it will be appreciate that system 200 is provided for the purposes of example only and is not necessarily required to practice the present disclosure. For example, the present disclosure can be implemented by a single computing device executing instructions from memory.

### Example Methods

FIG. 4 depicts a flow chart of an example method (400) for providing maps according to an example embodiment of the present disclosure. Although FIG. 4 depicts steps performed in a particular order for purposes of illustration and discussion, various steps of method (400) can be omitted, adapted, combined, and/or rearranged in various ways without departing from the scope of the present disclosure.

At (402) a request can be received from a first user for a map. For example, the first user can operate a mapping application or browser application to request a map from a central mapping service operated on one or more server computing devices. The server computing devices can receive the request for the map from the client device over a network.

At (404) user preferences data associated with the first user can be obtained. For example, in some embodiments, the first user can be identified by a device identifier associated with their client device or can be identified based on a user account into which the first user has previously signed. Having identified the first user, user preferences data can be obtained from a database storing such preferences data indexed by user. As another example, the user preferences data can obtained concurrently while mapping services are provided (e.g. through the collection and analysis of interactions between the first user and the provided map). In other embodiments, the user preferences data can be obtained at (404) by requesting and receiving user input, such as, for example, user input identifying various categories of semantic entities.

At (406) a semantic group can be selected or generated for the map requested by the first user. In particular, the semantic group can be selected or generated based at least in part on the user preferences data obtained at (404). For example, the user preferences data can indicate a use case or a particular category of semantic entity that the first user is expecting or desiring to explore on the map. A semantic group containing such category of semantic entities can be selected at (406).

At (408) the map can be provided to the first user. As an example, the server can provide map data to the client device over the network. The client device can use the map data to render or otherwise display a certain view of the map. For example, the map can have a default starting location and zoom level. In some embodiments, the default location and zoom level can be determined based on the selected semantic group. An appearance of the map (e.g. map design, map objects shown, or other map features) can be dependent upon the selected semantic group. In other embodiments, the map may be initially provided at a certain address or semantic entity that was provided by the first user when the map was requested. As another example, the initial location displayed by the map may be the user's current location.

At (410) zooming functionality can be provided within the map to the first user based at least in part on the semantic group selected at (406). In particular, zooming operations within the map can result in the displayed portion of the map being transitioned between defined geographic areas that correspond to semantic entities included within the semantic group selected at (406). For example, when a zoom out or a zoom in operation is requested, a particular semantic entity can be identified and the location and zoom level of the map can be adjusted so that the map is centered about and scaled relative to the geographic area associated with the particular identified semantic entity.

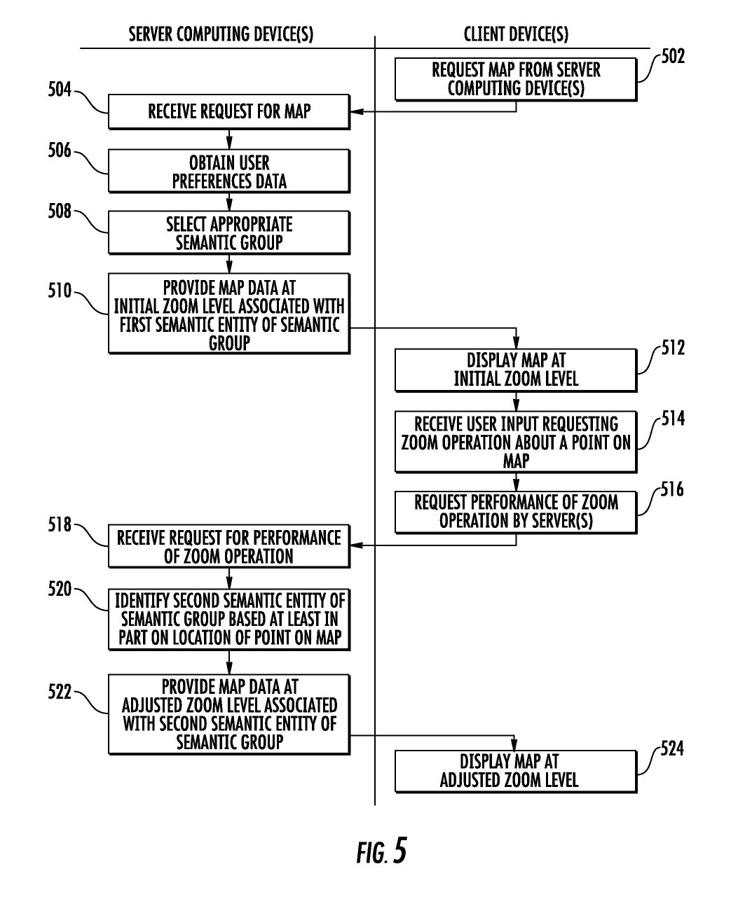

FIG. 5 depicts a flow chart of an example method (500) for providing maps according to an example embodiment of the present disclosure. Although method (500) will be discussed with reference to system 200 of FIG. 2, method (500) can be implemented using any suitable computing system. In addition, while FIG. 5 depicts steps performed in a particular order for purposes of illustration and discussion, various steps of method (500) can be omitted, adapted, combined, and/or rearranged in various ways without departing from the scope of the present disclosure.

At (502) the client device can request a map from the server computing device. For example, the client device can implement a mapping application or a browser application to communicate with the server and request map data. At (504) the server can receive the request for the map from the client device.

At (506) the server can obtain user preferences data. For example, the user preferences data may be accessed from a database storing preferences data for various users. The user preferences data can indicate various preferences or desires associated with the user for whom the map is intended. For example, the user preferences data can include data describing one or more previous interactions between the first user and the map (e.g. operations indicating that the first user has been exploring different national parks). As other examples, the user preferences data can include user search data associated with the first user, a user location history associated with the first user, user input specifying particular categories of desired semantic entities, and/or other data describing various preferences of the first user.

At (508) the server can select an appropriate semantic group. In particular, the semantic group can be selected based at least in part on the user preferences data obtained at (506). For example, if the first user has recently been searching for campgrounds in various national parks, then a semantic group that includes semantic entities generally including or focused on national parks or outdoor recreational entities can be selected for the first user. As another example, such semantic group can be selected in response to user input specifying “national parks” as a particular interest. As a result, the first user will be able to quickly zoom the displayed portion of the map between geographic areas corresponding to relevant semantic entities (e.g. particular parks and their campgrounds or other features), rather than repeatedly performing uniform, non-contextual zooming operations to reach particular portions of the map.

At (510) the server can provide to the client device map data for a map at an initial zoom level associated with a first semantic entity included in the semantic group selected at (508). At (512) the client device can display the map at the initial zoom level. For example, the map can be centered about and scaled relative to a first geographic area associated with the first semantic entity.

At (514) the client device can receive user input requesting that a zoom operation be performed about a point on the map. For example, the user can request a zoom in operation or a zoom out operation to be performed about a particular point on the map.

At (516) the client device can request performance by the server of the zoom operation requested by the user input. At (518) the server can receive from the client device the request for performance of the zoom operation.

At (520) the server can identify a second semantic entity included in the semantic group based at least in part on the location of the point on the map. In particular, the server can analyze a hierarchy or other data structure associated with the selected semantic group to identify various candidate semantic entities that may be one level higher or one level lower than the first semantic entity. If the point on the map about which the zoom operation is requested is within the geographic area associated with one of the candidate semantic entities, then such semantic entity can be identified at (520)

At (522) the server can provide to the client device map data for the map at an adjusted zoom level associated with the second semantic entity identified at (520). At (525) the client device can display the map at the adjusted zoom level. For example, the map can be centered about and scaled relative to a second geographic associated with the second semantic entity.

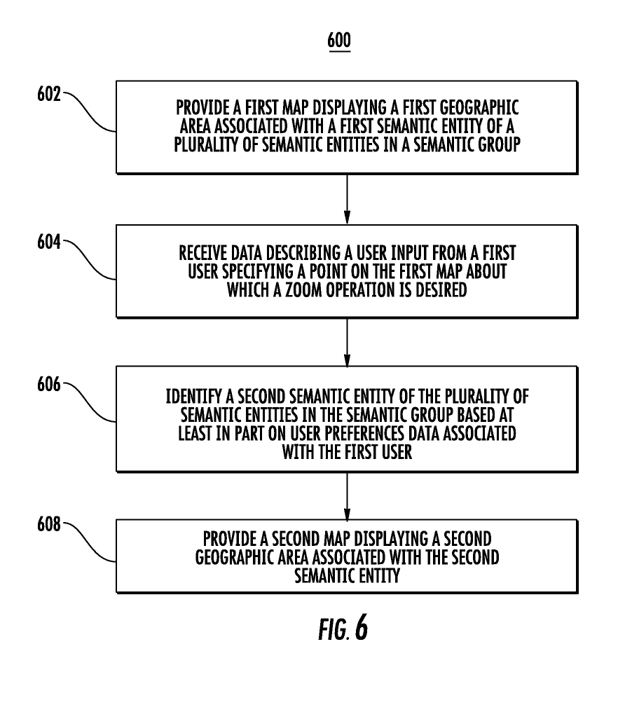

FIG. 6 depicts a flow chart of an example method (600) for providing maps according to an example embodiment of the present disclosure. Although FIG. 6 depicts steps performed in a particular order for purposes of illustration and discussion, various steps of method (600) can be omitted, adapted, combined, and/or rearranged in various ways without departing from the scope of the present disclosure.

At (602) a first map can be provided that displays a first geographic area associated with a first semantic entity. For example, the second map can be centered about and scaled relative to the second geographic area. The first semantic entity can be one of a plurality of semantic entities included in a semantic group.

At (604) data can be received that describes a user input from a first user. The user input can specify a point on the first map about which a zoom operation is desired. In particular, in some instances, the zoom operation may be requested about a point on the first map where the geographic areas of two or more semantic entities overlap. The two or more semantic entities may be included in the same semantic group or may belong to different semantic groups.

As an example, a user may be viewing a map depicting the San Francisco Bay area. The user may request to zoom in about a point that is included in both the geographic area corresponding to the semantic entity “Silicon Valley” and the geographic area corresponding to the semantic entity “San Jose Metropolitan Area.”

At (606) a second semantic entity of the plurality of semantic entities in the semantic group can be identified based at least in part on user preferences data associated with the first user. More particularly, one of the two or more overlapping semantic entities can be selected as the target of the zoom request. In some embodiments of the present disclosure, the particular semantic entity can be selected at (606) based at least in part on the user preferences data.

As an example, in some embodiments, when a zoom operation is ambiguous with respect to two or more semantic entities, the potential candidates for zooming can be scored based on the user preferences data. For example, previous searches, a user location history, or other information can be used to select one of the semantic entities for performing the resulting zoom operation. The semantic entity that receives the highest score may be selected at (606).

For example, if the user's home is located in Silicon Valley, but not the San Jose Metropolitan Area, then the semantic entity for Silicon Valley may be selected and be used to perform the zooming functionality. As another example, if the user is currently located in Silicon Valley, but not the San Jose Metropolitan Area, then the semantic entity for Silicon Valley may be selected and be used to perform the zooming functionality. As yet another example, if a user location history associated with the user indicates that the user is much more frequently located in Silicon Valley than the San Jose Metropolitan Area, then the semantic entity for Silicon Valley may be selected and be used to perform the zooming functionality.

At (608) a second map can be provided that displays a second geographic area associated with the second semantic entity identified at (606). For example, the second map can be centered about and scaled relative to a second geographic area associated with the second semantic entity.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

Furthermore, computing tasks discussed herein as being performed at a server can instead be performed at a client device. Likewise, computing tasks discussed herein as being performed at the client device can instead be performed at the server.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for providing maps, the method comprising:
obtaining, by one or more computing devices, user preferences data describing one or more attributes associated with a first user;
selecting, by the one or more computing devices, a first semantic group from a plurality of semantic groups based at least in part on the user preferences data, wherein each of the plurality of semantic groups comprises a plurality of different semantic entities, and wherein a plurality of different geographic areas are respectively associated with the plurality of different semantic entities;
providing, by the one or more computing devices, a map to the first user, wherein the map comprises at least a portion of one or more of the plurality of different geographic areas; and
providing, by the one or more computing devices, zooming functionality within the map to the first user based at least in part on the first semantic group, wherein the zooming functionality allows the first user to zoom a displayed portion of the map between the plurality of different geographic areas respectively associated with the plurality of different semantic entities included in the first semantic group.

2. The computer-implemented method of claim 1, wherein:
the plurality of semantic groups are respectively organized according to a plurality of hierarchies; and
providing, by the one or more computing devices, the zooming functionality within the map to the first user based at least in part on the first semantic group comprises providing, by the one or more computing devices, the zooming functionality within the map to the first user based at least in part on the hierarchy associated with the first semantic group.

3. The computer-implemented method of claim 2, wherein:
the plurality of hierarchies comprise a plurality of directed graphs; and
the directed graph for each semantic group comprises a plurality of nodes respectively corresponding to the plurality of different semantic entities included in such semantic group.

4. The computer-implemented method of claim 2, wherein providing, by the one or more computing devices, the zooming functionality within the map to the first user based at least in part on the hierarchy associated with the first semantic group comprises:
providing, by the one or more computing devices, a first view of the map that is based at least in part on a first geographic area associated with a first semantic entity of the first semantic group;
receiving, by the one or more computing devices, data describing a user input requesting a zoom out operation to be performed at a first point on the map;
identifying, by the one or more computing devices, a second semantic entity of the first semantic group based at least in part on the first point on the map, wherein the second semantic entity is one level higher than the first semantic entity according to the hierarchy; and
providing, by the one or more computing devices, a second view of the map that is based at least in part on a second geographic area associated with the second semantic entity.

5. The computer-implemented method of claim 2, wherein providing, by the one or more computing devices, the zooming functionality within the map to the first user based at least in part on the hierarchy associated with the first semantic group comprises:
providing, by the one or more computing devices, a first view of the map that is based at least in part on a first geographic area associated with a first semantic entity of the first semantic group;
receiving, by the one or more computing devices, data describing a user input requesting a zoom in operation to be performed at a first point on the map;
identifying, by the one or more computing devices, a second semantic entity of the first semantic group based at least in part on the first point on the map, wherein the second semantic entity is one level lower than the first semantic entity according to the hierarchy; and
providing, by the one or more computing devices, a second view of the map that is based at least in part on a second geographic area associated with the second semantic entity.

6. The computer-implemented method of claim 1, wherein selecting, by the one or more computing devices, the first semantic group from the plurality of semantic groups based at least in part on the user preferences data comprises generating, by the one or more computing devices, the first semantic group based at least in part on the user preferences data by selecting one or more of the plurality of different semantic entities that comprise the first semantic group.

7. The computer-implemented method of claim 6, wherein generating, by the one or more computing devices, the first semantic group based at least in part on the user preferences data by selecting one or more of the plurality of different semantic entities that comprise the first semantic group comprises generating, by the one or more computing devices, the first semantic group by adding to an existing semantic group one or more semantic entities associated with the first user.

8. The computer-implemented method of claim 7, wherein the one or more semantic entities associated with the first user comprise one or more of a home location and a work location.

9. The computer-implemented method of claim 1, wherein selecting, by the one or more computing devices, the first semantic group from the plurality of semantic groups based at least in part on the user preferences data comprises selecting, by the one or more computing devices, the first semantic group from the plurality of semantic groups based at least in part on the user preferences data and based at least in part on an identity of a portal through which the map is provided to the first user.

10. The computer-implemented method of claim 1, wherein the user preferences data comprises data describing one or more previous interactions between the first user and the map.

11. The computer-implemented method of claim 1, wherein the user preferences data comprises a user input describing one or more categories of geographic entities.

12. The computer-implemented method of claim 1, wherein the user preferences data comprises one or more of a user location history associated with the first user and user search data associated with the first user.

13. The computer-implemented method of claim 1, further comprising modifying, by the one or more computing devices, a membership of one or more of the semantic entities of one or more of the semantic groups based at least in part on one or more zooming actions performed by additional users within the map.

14. A system for providing maps, the system comprising:
one or more server computing devices configured to perform first operations, the first operations comprising:
receiving a request for a map from a first client device associated with a first user;
obtaining user preferences data associated with the first user;
selecting a first semantic group from a plurality of semantic groups based at least in part on the user preferences data, wherein each of the plurality of semantic groups comprises a plurality of different semantic entities, and wherein a plurality of different geographic areas are respectively associated with the plurality of different semantic entities; and
providing the map to the first client device, wherein zooming functionality is provided to the first user within the map based at least in part on the first semantic group, and wherein the zooming functionality allows the first user to zoom a displayed portion of the map between the plurality of different geographic areas respectively associated with the plurality of different semantic entities included in the first semantic group.

15. The system of claim 14, wherein:
wherein a plurality of hierarchies are respectively associated with the plurality of semantic groups, the semantic entities respectively included in each of the plurality of semantic groups being organized according to the hierarchy associated with such semantic group; and
the zooming functionality allows the first user to zoom the displayed portion of the map between geographic areas respectively associated with semantic entities being at adjacent levels in the hierarchy associated with the first semantic group.

16. The system of claim 14, further comprising the first client device, wherein the first client device is configured to perform second operations, the second operations comprising:
displaying a first geographic area associated with a first semantic entity of the first semantic group;
receiving a user input requesting a zoom operation to be performed about a first point on the displayed portion of the map; and
displaying, in response to the user input, a second geographic area associated with a second semantic entity of the first semantic group.

17. The system of claim 14, wherein selecting the first semantic group from the plurality of semantic groups based at least in part on the user preferences data comprises selecting the first semantic group based at least in part on one or more of user search data associated with the first user, a user location history associated with the first user, user input identifying one or more categories, and one or more previous operations performed by the first user with respect to the map.

18. One or more non-transitory, computer-readable media storing instructions that, when executed by one or more computing devices, cause the one or more computing devices to perform operations, the operations comprising:
providing a first map displaying a first geographic area associated with a first semantic entity of a plurality of semantic entities in a semantic group, wherein the plurality of semantic entities of the semantic group are organized according to a hierarchy based at least in part on a plurality of geographic areas respectively associated with the semantic entities;
receiving data describing a user input from a first user specifying a point on the first map about which a zoom operation is desired;
identifying a second semantic entity of the plurality of semantic entities based at least in part on the point on the first map and based at least in part on user preferences data associated with first user, the second semantic entity being one level from the first semantic entity in the hierarchy; and
providing a second map displaying a second geographic area associated with the second semantic entity.

19. The one or more non-transitory, computer-readable media of claim 18, wherein identifying, by the one or more computing devices, the second semantic entity of the plurality of semantic entities based at least in part on the point on the first map and based at least in part on user preferences data associated with first user comprises:
identifying the second semantic entity and a third semantic entity of the plurality of semantic entities based at least in part on the point on the first map; and
selecting the second semantic entity in favor of the third semantic entity based at least in part on the user preferences data associated with the first user.

20. The one or more non-transitory, computer-readable media of claim 19, wherein the point on the first map lies within an overlapping region exhibited by the second geographic area and the third geographic area.
